(19) United States
(12) Patent Application Publication
(10) Pub. No.: US 2013/0000748 A1
(43) Pub. Date: Jan. 3, 2013

(54) DEVICE FOR EJECTING GAS FROM A GAS TURBINE ENGINE AND GAS TURBINE ENGINE

(75) Inventors: Eric Jean-Louis Bouty, Pau (FR); Pierre-Luc Regaud, Pau (FR); Antoine Yvan Alexandre Vallon, Pau (FR)

(73) Assignee: TURBOMECA, Bordes (FR)

(21) Appl. No.: 13/578,754

(22) PCT Filed: Feb. 9, 2011
(86) PCT No.: PCT/FR2011/050277

§ 371 Date: Sep. 17, 2012

(30) Foreign Application Priority Data
Feb. 12, 2010 (FR) 1000592

(51) Int. Cl. B23P 11/00

(52) U.S. Cl. 137/315.01

(57) ABSTRACT

A device for ejecting gas from a gas turbine engine, which includes: an outer wall and an inner wall defining a gas flow path therebetween, the inner wall forming a central body defining an inner cavity, the outer wall being perforated and communicating with at least one outer resonance cavity for attenuating noise in a first range of sound frequencies; and a mechanism for placing the outer and inner cavities in fluid communication, extending through the gas flow path, the inner cavity thus forming a resonance cavity for attenuating the noise in a second range of sound frequencies. The device can, for example, be used to attenuate two ranges of sound frequencies.

The invention relates to the field of reducing noise from a gas turbine engine.

A gas turbine engine for an aircraft such as an airplane or helicopter generally comprises, moving from upstream to downstream in the direction of flow of the gases, one or more compressor stages, a combustion chamber, one or more turbine stages and a device for ejecting the gases such as a nozzle.

A continual problem for engine manufacturers is the reduction of noise, in particular for the sake of the comfort of passengers and those living below the flight paths of the aircraft. In particular, helicopters travel in the vicinity of populated areas and the noise emitted by their exhaust nozzle forms a significant component of the total noise which they generate. The attenuation of the noise emitted by the nozzle may be obtained by the use of an acoustic attenuation casing forming the internal wall of the nozzle and thus the external envelope of the gas stream. Such a casing may, for example, comprise a perforated metal sheet opening into one or more resonance cavities, each group of one cavity and one or more orifices forming a Helmholtz resonator. The cavities may, for example, have a honeycomb-type structure or simply be formed by transverse and/or longitudinal partitions.

Such casings for acoustic attenuation or treatment generally permit the attenuation of so-called medium sound frequencies, for example ranging between 2 and 5 kHz. The treated sound frequencies depend, in particular, on the depth of the resonance cavities which are thus dimensioned for this purpose.

More specifically, a gas turbine engine generates noise at different frequencies. In the case of a gas turbine engine for a helicopter, noise peaks are generally observed in a first range of (low) frequencies around 0.5 kHz and in a second range of (medium) frequencies around 2 kHz. Whilst it is possible in a simple manner to dimension the resonance cavities to attenuate the sounds from the second range of frequencies, it is quite difficult to attenuate the sounds from the first range of frequencies, due to spatial restrictions, since their attenuation would involve the use of cavities which are too deep in terms of the volume available. More specifically, said low frequency sounds are the source of unpleasant noise, in particular when the helicopter takes off.

The object of the present invention is to propose a nozzle for a gas turbine engine permitting the efficient attenuation of several frequency ranges, in particular low and medium frequencies.

The invention relates particularly well to the attenuation of noise from a nozzle for a gas turbine engine of a helicopter. However, the scope of the applicant's rights is not limited to this single application, the invention relating more generally to a device for the ejection of gas from a gas turbine engine.

Thus, the invention relates to a device for ejecting gas from a gas turbine engine comprising an external wall and an internal wall defining therebetween a gas flow stream, the internal wall forming a central body defining an internal cavity, the external wall being perforated and communicating with at least one external resonance cavity for the attenuation of noise in a first range of sound frequencies, also comprising means for placing the external and internal cavities in fluidic communication, extending through the gas flow stream, the internal cavity thus forming a resonance cavity for the attenuation of noise in a second range of sound frequencies. The device is characterized in that the means for placing in fluidic communication comprise radial arms which also fulfill the function of mechanical retention of the central body.

Due to the invention, it is possible to attenuate the noises from two ranges of sound frequencies without increasing the volume of the cavity(ies) located on the external side of the gas stream. Thus, with the same volume, it is possible to attenuate the noises, which would not have been possible in the prior art. Finally, by means of the invention, the external and internal cavities form a single resonance cavity which is able to treat a plurality of ranges of sound frequencies.

According to a preferred embodiment, the arms are hollow and open into the external resonance cavity in the region of the external wall and into the internal resonance cavity in the region of the internal wall.

According to a preferred embodiment, the internal wall comprises an acoustic attenuation casing on its internal side.

According to a preferred embodiment, the first range of sound frequencies corresponds to medium frequencies, for example centered around 2 kHz, and the second range of sound frequencies corresponds to low frequencies, for example centered around 0.5 kHz.

It is noteworthy that the external and internal cavities could alternatively attenuate the same sound frequency range (the attenuated frequency ranges being entirely or partially superposed), the object of the invention thus being to increase the efficiency of the attenuation over this range.

According to a preferred embodiment, the internal cavity and/or the external cavity is/are partitioned for adjusting the frequencies which they attenuate. In other words, the cavity(ies) comprise one or more partitions; and the volumes created between the partitions may be identical or different. Said volumes are dimensioned according to the frequencies at which it is desired to provide the acoustic treatment, in the manner known to the person skilled in the art.

According to an embodiment, in this case the partitions also fulfill a structural function.

According to a preferred embodiment, the device for ejecting gas is a gas ejection nozzle of a gas turbine engine.

The invention also relates to a gas turbine engine comprising a device for ejecting gas as set forth above.

The invention will be understood more clearly with reference to the following description of the preferred embodiment of the invention, with reference to the accompanying drawings, in which:

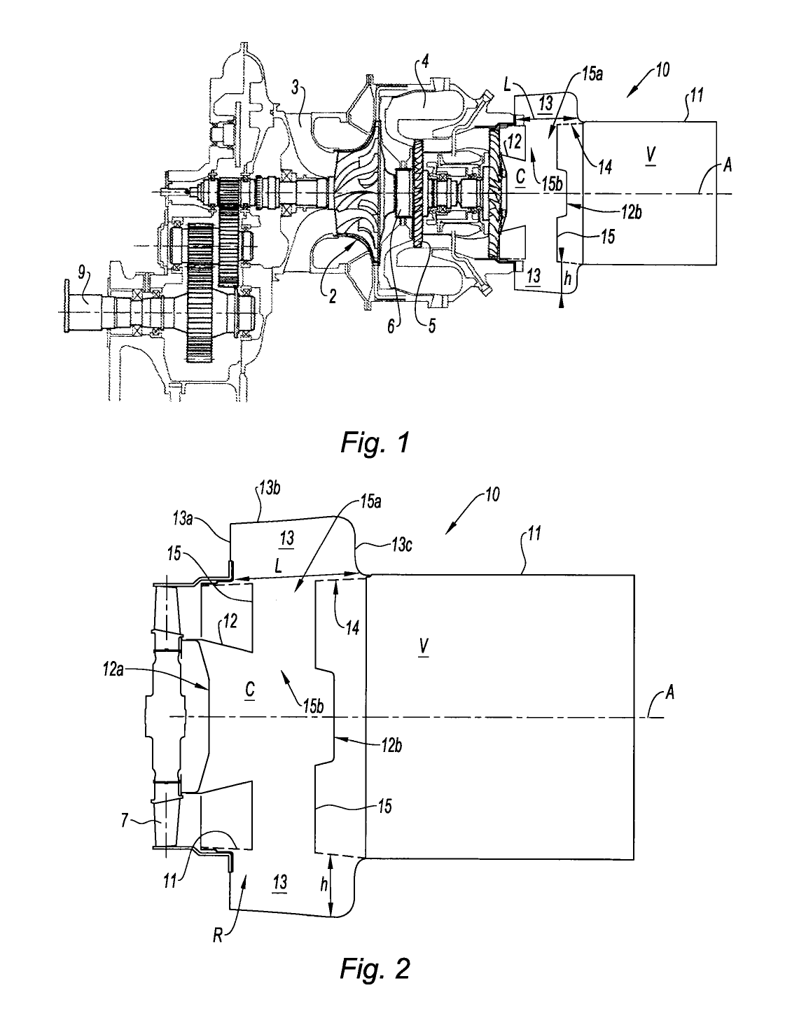

FIG. 1 shows a schematic sectional view of a gas turbine engine for a helicopter with a nozzle according to the preferred embodiment of the invention;

FIG. 2 is an axial schematic sectional view of the nozzle of the engine of FIG. 1, and

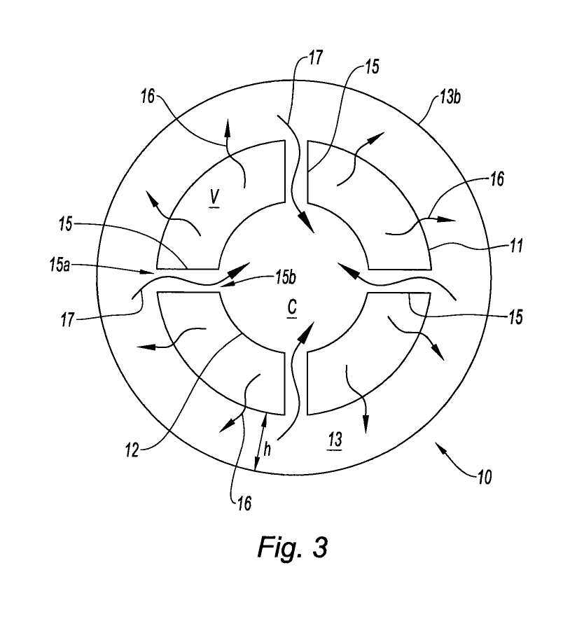

FIG. 3 is a front view, from the downstream side, of the nozzle of FIG. 2.

With reference to FIG. 1, and in the known manner, a gas turbine engine of a helicopter comprises a compressor 2 (in this case centrifugal and comprising a single stage) supplied with external air by an annular air inlet channel 3, an annular combustion chamber 4 (which in this case has reverse flow), provided with injectors (not shown) permitting it to be supplied with fuel for the combustion of compressed gases from the compressor 2. The combusted gases drive a first turbine 5 (in this case comprising a single stage) connected to the compressor 2 by a shaft 6 which fixes them in rotation, and a second so-called power turbine 7 (in this case comprising a single stage) connected by a shaft to a gear unit permitting a transfer of mechanical energy from the power turbine 7 to an output shaft 9, for example connected to a rotor driving the helicopter blades.

At the outlet of the power turbine 7, the engine comprises a gas ejection device 10, in this case a gas ejection nozzle 10, the function thereof being to guide the exhaust gases along a gas flow stream V or gas stream V, from upstream to downstream.

The nozzle 10 (and thus its walls 11, 12) generally extends along an axis A. Unless indicated to the contrary, the concepts of longitudinal, radial, transverse, internal or external are used in the remainder of the description with reference to said axis A.

The nozzle 10 comprises an external wall or housing 11 (generally of cylindrical shape) and an internal wall or housing 12. Longitudinally, the internal wall 12 is less long than the external wall 11 and thus only extends vertically from an upstream part thereof. The external wall 11 defines the external envelope of the gas stream V, whilst the internal wall 12 defines the internal envelope of the gas stream V (on the corresponding upstream portion).

In other words, the gases flow between the internal wall 12 and external wall 11. The external wall 11 is sometimes referred to as a “diffuser”.

The internal wall 12 of the nozzle 10 forms a central body 12 of the nozzle 10. In this case it is in the form of a wall having symmetry of revolution about the axis A of the turbojet; the central body 12 is frustoconical in shape and closed at its upstream end 12a and at its downstream end 12b (by corresponding walls visible in FIG. 2). The person skilled in the art sometimes denotes a central nozzle body by its English term “plug”; and also sometimes by the term “cone”, since a central body is often generally of frustoconical shape. Reference is made hereinafter equally to the internal wall 12 or the central body 12, said two concepts being interchangeable. The central body 12 defines an internal cavity C corresponding to its internal volume.

The nozzle 10 also comprises an external cavity 13, in this case of annular shape and extending about an upstream portion of the external wall 11 of the nozzle 10 located at least partially vertically from the central body 12. Said external cavity 13 is defined by upstream 13a, external 13b and downstream 13c walls, as well as, on the inside, by said upstream portion of the external wall 11. The external wall 11 is perforated by a plurality of orifices 14 (shown schematically in FIG. 1); said orifices 14 fulfill the function of placing the gas stream V in fluidic communication with the resonance cavity 13 to attenuate noise and to this end said orifices open out on both sides of the internal wall 12; they are, for example, distributed according to a square mesh but any type of distribution is conceivable. The external wall 11 is in this case perforated over its entire upstream surface corresponding to the external cavity 13. The external cavity 13 and the perforated external wall 11 form an acoustic attenuation casing R of the quarter wave resonator type. Said casing R in this case directly forms the external envelope of the nozzle.

The nozzle 10 also comprises radial arms 15, fulfilling in this case the function of mechanical retention of the central body 12; said arms 15 extend between the external wall 11 and the internal wall 12 and are fixed to each of said walls 11, 12, for example by welding or even by riveting. The radial arms 15 are in this case four in number, distributed at a uniform angle, i.e. diametrically opposing one another in pairs, successive arms 15 being separated by 90°. More generally, the number of arms 15 preferably ranges between 3 and 5, the arms preferably being distributed uniformly at an angle.

Apart from their function of mechanical retention of the central body 12, the arms 15 are arranged to place the external cavity 13 and the internal cavity C in fluidic communication with one another to permit sound to pass from one to another, thus permitting the internal cavity C to form a resonance cavity to attenuate the sounds which are propagated therein.

More specifically, the arms 15 are hollow and on their external side open into the external cavity 13, and on their internal side into the internal cavity C. In this case, they are completely open both on the external side 15a and on the internal side 15b, i.e. they are open at their external radial end 15a and internal radial end 15b, along their entire section which is transverse to their radial dimension.

According to a further embodiment, not shown, the arms 15 are only partially open at their external end 15a and/or their internal end 15b; for example, an arm 15 may comprise, in the region of one and/or other of its external 15a and internal 15b ends, a perforated metal sheet physically separating the internal volume of the arm 15 from the external cavity 13 and/or internal cavity C, but nevertheless permitting a fluidic communication between the volumes under consideration. This makes it possible, if it is desirable, to improve the acoustic treatment by the resistive layer thus created.

Whatever the embodiment, the sound is propagated through perforations 14 of the external wall 11 from the gas stream V into the external resonance cavity 13, as illustrated schematically by the arrows 16. The depth of the external cavity 13 is dimensioned (as explained below) to permit the attenuation of a first band of sound frequencies, in this case a medium frequency range centered around 2 to 2.5 kHz.

Due to the arms 15 for placing the external cavity 13 and internal cavity C in fluidic communication, the sound is also propagated from the external cavity 13 into the internal cavity C, as illustrated schematically by the arrows 17. This makes it possible to attenuate a second band of sound frequencies in the resonance cavity formed by the internal cavity C, in which the sound is propagated from the external cavity 13 via radial arms 15.

Preferably, due to the relatively high volume which the central body 12 is able to define for the internal cavity C, said cavity may permit the attenuation of a low frequency range, for example ranging from 0.3 to 1 kHz.

The attenuation of two frequency ranges is carried out without the use of an additional volume for the nozzle 10 relative to a nozzle of the prior art which would have comprised a central body and an external cavity similar to that of the nozzle 10; more specifically, the additional volume used for the acoustic attenuation is that of the central body 12 which is reached, due to the radial arms 15, via the external cavity 13.

The different constituent elements of the nozzle 10 are preferably metal, for example made from steel based on nickel or titanium.

The adjustment of frequency ranges treated by the nozzle 10 is based, in particular, on the volume of the external cavity 13 and internal cavity C.

Thus, the adjustment of the frequency of the external acoustic attenuation casing (i.e. the determination of the principal frequencies which it attenuates) is made, in particular, by adjusting the volume of the external cavity 13 and more particularly by adjusting its radial depth. More specifically, the acoustic attenuation casing R functions according to the principle of a so-called “quarter wave” resonator, i.e. a resonator of which the depth is equal to a quarter of the wavelength of the central frequency of the band of frequencies which it attenuates. Thus, the more it is desired to attenuate high frequencies, the smaller the radial depth of the cavity 13 has to be. In contrast, the more it is desired to attenuate low frequencies, the greater the radial depth of the cavity 13 has to be. Depending on the frequencies to be attenuated, the cavity 13 may also be partitioned into a plurality of cavities (the partition walls being able to be longitudinal or transverse); in this case it is also possible to use a honeycomb-type structure; the partition walls may also fulfill a function of mechanical retention. The length L or longitudinal dimension L of the cavity 13 acts, in turn, on the rate or efficiency of the resulting acoustic attenuation.

For example, to attenuate a frequency band centered on 2 kHz, it is possible to provide a single cavity 13 of a radial depth of 4 cm, the external wall 11 having a porosity (ratio of the cumulative surface of the orifices 14 to the total surface) of preferably between 5 and 10%, for example of 8%.

Similarly, the adjustment of the frequency of the central body 12 is made by adjusting its volume. Its shape is thus adapted to the highest frequencies desired to be attenuated, typically a range of frequencies centered around 0.3 or 0.5 kHz. The volume of the radial arms 15 also contributes to the acoustic attenuation and may be taken into account. According to the embodiment disclosed, the cone has a longitudinal dimension of between 11 and 23 cm and a radius of between 6 and 12 cm.

According to an embodiment, not shown, the internal cavity C and/or the external cavity 11 is/are partitioned by at least one partition for adjusting the frequencies of the noise which they attenuate. Said partition(s) may also fulfill a structural function of stiffener(s).

According to an embodiment, not shown, to improve further the acoustic attenuation obtained by the central body 12, said body comprises an acoustic attenuation casing on the internal side of the internal wall 12. This is particularly advantageous in that, as the internal cavity C is not directly subjected to the flow of exhaust gas, it is possible to use for this casing materials which are not traditionally able to be used for the treatment of an external nozzle wall as they are incompatible with the conditions to which they would be subjected by the exhaust gases.

The central body 12 has been described as frustoconical. It is noteworthy that, depending on the engine and its aerodynamic constraints, the central body may have other shapes having symmetry of revolution (for example a cylindrical shape). It is also possible for the central body not to have symmetry of revolution in order to reduce the noise of the gas jet or reduce the infrared signature; in this case the central body may have an undulated, rectangular or elliptical cross section, for example. The present invention applies to all shapes of central body, in that they are able to define a resonance cavity connected to the external cavity of the nozzle by means extending through the gas stream V.

It is noteworthy, moreover, that, in certain gas turbine engines and in particular in aircraft turbojets, the central body 12 may fulfill a further function which is to guide the degassing flow of the engine. More specifically, in certain engines, a degassing orifice is provided at the downstream end of its central shaft, through which various fluids escape, such as oil vapor, certain cooling gases, etc. Generally this is referred to as an “oil separator”. In this case, either a pipe for guiding the degassing flow extends inside the central body as far as its end, for channeled guidance of the degassing flow, or a pipe is not provided, the central body ensuring the guidance of the degassing flow by means of its internal surface. The degassing is generally carried out by suction, the pressure inside the pipe or the central body being lower than the pressure in the housing of the turbojet. This guidance function of the degassing flow may be combined with the resonance cavity function of the invention.

It is also noteworthy that resonance cavities may also be provided downstream of the external cavity 13 to improve the acoustic attenuation further.

It is also noteworthy that an ejector (supplying the nozzle with a secondary gas flow) may be provided in the nozzle, the presence of such an ejector not being incompatible with the invention.

In engines where this is necessary, the radial arms 15 may also permit the passage of ancillary equipment, such as cables or electrical harnesses, ducts for the transportation of fluid, etc.

The invention has been disclosed with regard to a rectangular nozzle along an axis A. According to an embodiment, not shown, the nozzle may be of curved shape, which may be useful when applied to a helicopter, such an embodiment not being incompatible with the invention.

1-8. (canceled)

9. A device for ejecting gas from a gas turbine engine, comprising:
an external wall and an internal wall defining therebetween a gas flow stream, the internal wall forming a central body defining an internal cavity, the external wall being perforated and communicating with at least one external resonance cavity for attenuation of noise in a first range of sound frequencies; and
means for placing the external cavity and internal cavity in fluidic communication, extending through the gas flow stream, the internal cavity thus forming a resonance cavity for the attenuation of noise in a second range of sound frequencies,
wherein the means for placing in fluidic communication comprises radial arms also fulfilling a function of mechanical retention of a central body.

10. The device for ejecting gas as claimed in claim 9, in which the arms are hollow and open into the external resonance cavity in a region of the external wall and into the internal resonance cavity in a region of the internal wall.

11. The device for ejecting gas as claimed in claim 9, in which the internal wall comprises an acoustic attenuation casing on its internal side.

12. The device for ejecting gas as claimed in claim 9, in which the first range of sound frequencies corresponds to medium frequencies, or is centered around 2 kHz, and the second range of sound frequencies corresponds to low frequencies, or is centered around 0.5 kHz.

13. The device for ejecting gas as claimed in claim 9, in which the internal cavity and/or the external cavity comprise at least one partition for adjusting the frequencies of the noise which they attenuate.

14. The device for ejecting gas as claimed in claim 13, in which the partition also fulfills a structural function.

15. The device for ejecting gas as claimed in claim 9, which is a gas ejection nozzle of a gas turbine engine.

16. A gas turbine engine comprising a device for ejecting gas as claimed in claim 9.
